(19) United States
(12) Patent Application Publication
(10) Pub. No.: US 2024/0020226 A1
(43) Pub. Date: Jan. 18, 2024

(54) DATA STORAGE DEVICE, MEMORY CONTROLLER THEREFOR, AND OPERATING METHOD THEREOF

(71) Applicant: SK hynix Inc., Gyeonggi-do (KR)

(72) Inventors: Dong Ham YIM, Gyeonggi-do (KR); Duck Joo LEE, Gyeonggi-do (KR)

(21) Appl. No.: 18/081,697

(22) Filed: Dec. 15, 2022

(30) Foreign Application Priority Data
Jul. 14, 2022 (KR) 10-2022-0087063

(51) Int. Cl. G06F 12/02; G06F 12/0831; G06F 13/16

(52) U.S. Cl. CPC G06F 12/0246; G06F 12/0833; G06F 13/1668

(57) ABSTRACT

A data storage device may include a storage configured to receive and program data in units of first sizes or read and output data in the units of first sizes and a memory controller. The memory controller is configured to generate a mapping information slice having a first size as a trim command including a first logical address which is transmitted thereto from an external device, the mapping information slice including trim bitmap data and first mapping data for the first logical address, and store the mapping information slice in the storage.

### CROSS-REFERENCES TO RELATED APPLICATION

The present application claims priority under 35 U.S.C. § 119(a) to Korean application number 10-2022-0087063, filed on Jul. 14, 2022, which is incorporated herein by reference in its entirety.

### BACKGROUND

### 1. Technical Field

The present technology relates to a semiconductor integrated device, and more particularly, to a data storage device, a memory controller therefor, and an operating method thereof.

### 2. Related Art

A data storage device uses a volatile or nonvolatile memory device as a storage medium, and performs data input/output operations according to a request from a host device.

A flash memory is widely used as a storage medium for a data storage device because of its advantages such as large capacity, nonvolatility, low unit cost, low power consumption, and high data processing speed.

Since the flash memory is not overwritten, when a file is deleted by a host device, a file system of the host device treats the file as deleted, but the data storage device needs to perform a complicated operation for managing the deleted file.

For example, when the host device intends to delete a certain file, the file system treats the file as deleted and transmits a trim command to the data storage device.

The data storage device may manage the corresponding file as being invalidated in response to the trim command and recover a corresponding storage space as an empty space by deleting the invalidated file through a background operation.

Therefore, it is necessary to accurately manage the validity of a file stored in the storage medium of the data storage device before the file is actually deleted.

### SUMMARY

A data storage device in accordance with an embodiment of the present disclosure may include: a storage configured to receive and program data in units of first sizes or read and output data in the units of first sizes; and a memory controller configured to control data input/output to/from the storage according to mapping data between a logical address used by an external device and a physical address used by the storage, generate a mapping information slice having the first size as a trim command including a first logical address which is transmitted thereto from the external device, the mapping information slice including trim bitmap data and first mapping data for the first logical address, and store the mapping information slice in the storage.

A memory controller in accordance with an embodiment of the present disclosure may include: a meta data management circuit configured to generate a mapping information slice including mapping data between a logical address of an external device and a physical address of a storage; a trim command processing circuit configured to generate trim bitmap data as a trim command including a first logical address which is transmitted from the external device, and configure a mapping information slice having a first size by putting the trim bitmap data into the mapping information slice including first mapping data for the first logical address; and a processor configured to control data input/output to/from the storage in units of the first sizes and store the mapping information slice in the storage.

An operating method of a data storage device in accordance with an embodiment of the present disclosure may include: preparing a storage that receives and programs data in units of first sizes, or reads and outputs data in the units of first sizes; generating, by a memory controller that controls the storage, a mapping information slice including mapping data between a logical address used by an external device and a physical address used by the storage; generating, by the memory controller, trim bitmap data for a first logical address as a trim command including the first logical address which is received from the external device; configuring, by the memory controller, a flapping information slice having the first size by putting the trim bitmap data into the mapping information slice including first mapping data for the first logical address; and storing, by the memory controller, the mapping information slice in the storage.

An operating method of a data storage device in accordance with an embodiment of the present disclosure may include: flushing, in units of pages, one or more map slices from a buffer into a memory device; and rebuilding a mapping relationship between logical and physical addresses indicating a storage unit by loading, in the units of pages, one or more of the flushed map slices from the memory device onto the buffer, wherein each of the map slices includes: first information representing the mapping relationship, and second information indicating whether the mapping relationship is invalid, and wherein the rebuilding includes referring to the second information within the loaded map slices

### BRIEF DESCRIPTION OF THE DRAWINGS

FIG. 1 is a configuration diagram of a data processing system in accordance with an embodiment of the present disclosure.

FIG. 2 is a configuration diagram of a memory controller in accordance with an embodiment of the present disclosure,

FIG. 3 is a diagram for describing a meta data management concept in accordance with an embodiment of the present disclosure.

FIG. 4 is a configuration diagram of Meta Data in accordance with an embodiment of the present disclosure.

FIG. 5 is a configuration diagram of a meta slice in accordance with an embodiment of the present disclosure.

FIG. 6 is a flowchart for describing an operating method of a data storage device in accordance with an embodiment of the present disclosure.

FIG. 7 is a flowchart for describing an operating method of the data storage device in accordance with an embodiment of the present disclosure.

FIG. 8 is a flowchart for describing an operating method of the data storage device in accordance with an embodiment of the present disclosure.

### DETAILED DESCRIPTION

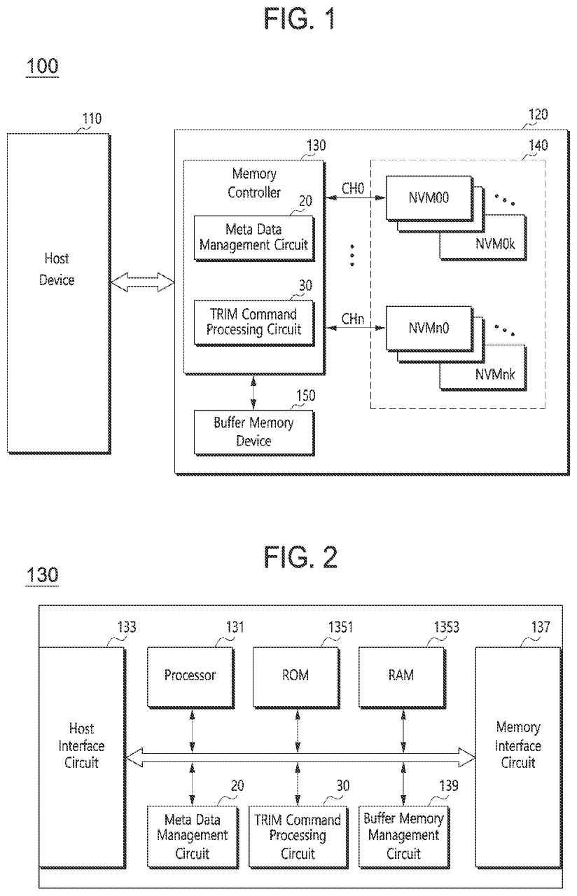

Hereinafter, embodiments of the present disclosure will be described in more detail with reference to the accompanying drawings, to FIG. 1 is a configuration diagram of a data processing system 100 in accordance with an embodiment of the present disclosure.

Referring to FIG. 1, the data processing system 100 may include a host device 110 and a data storage device 120.

Examples of the host device 110 include portable electronic devices such as mobile phones and MP3 players, personal electronic devices such as laptop computers, desktop computers, game machines, televisions, and beam projectors, or electronic devices for processing large-capacity data such as workstations or servers. The host device 110 may serve as a master device with respect to the data storage device 120.

The data storage device 120 is configured to operate in response to a request from the host device 110. The data storage device 120 is configured to store data accessed by the host device 110. That is, the data storage device 120 may be used as a main storage device or an auxiliary storage device of the host device 110. The data storage device 120 may include a memory controller 130, a storage 140, and a buffer memory device 150. The memory controller 130 may serve as a master device with respect to the storage 140. The data storage device 120 may be configured as a memory card connected to the host device 110 through various interfaces. In an embodiment, the data storage device 120 may be configured as a solid state drive (SSD).

The memory controller 130 is configured to control the storage 140 in response to a request from the host device 110. For example, the memory controller 130 is configured to store data provided from the host device 110 in the storage 140 or provide the host device 110 with data read from the storage 140. For such an operation, the memory controller 130 is configured to control read, program (or write), and erase operations on the storage 140.

The buffer memory device 150 may serve as a space for temporarily storing data when the data storage device 120 inputs and outputs the data in cooperation with the host device 110. In FIG. 1, the buffer memory device 150 is located outside the memory controller 130; however, the buffer memory device 150 may be provided inside the memory controller 130.

The storage 140 may be connected to the memory controller 130 through one or more channels CH0 to CHn, and may include one or more nonvolatile memory devices NVM00 to NVM0k and NVMn0 to NVMnk. In an embodiment, each of the nonvolatile memory devices NVM00 to NVM0k and NVMn0 to NVMnk may be configured as at least one of various types of nonvolatile memory devices such as a NAND flash memory device, a NOR flash memory device, a ferroelectric random access memory (FRAM) using a ferroelectric capacitor, a magnetic RAM (MRAM) using a tunneling magneto-resistive (TMR) film, a phase change RAM (PRAM) using chalcogenide alloys, and a resistive RAM (RERAM) using a transition metal oxide.

Each of the nonvolatile memory devices NVM00 to NVM0k and NVMn0 to NVMnk includes a plurality of memory cells. Each of the memory cells may operate as a single level cell (SLC) capable of storing one bit of data or a multi-level cell (MLC) capable of storing two bits or more of data.

Each of the nonvolatile memory devices NVM00 to NVM0k and NVMn0 to NVMnk may be configured to operate as a single level cell (SLC) memory device or as a multi-level cell (MLC) memory device. Alternatively, among the nonvolatile memory devices NVM00 to NVM0k and NVMn0 to NVMnk, some may be configured to operate as single level cell (SLC) memory devices or others may be configured to operate as multi-level cell (MLC) memory devices.

A group of memory cells connected to substantially the same word line among memory cells constituting the nonvolatile memory devices NVM00 to NVM0k and NVMn0 to NVMnk may be referred to as a page, and a set of pages connected to a plurality of word lines may be referred to as a memory block. A set of pages connected to the same or different word lines included in a plurality of memory blocks may be referred to as a super page. The storage 140 may read data or be programmed in units of pages or super pages, and may be erased in units of memory blocks.

A logical address used by the host device 110 for data input/output may be different from a physical address assigned to a storage space of the storage 140. In order to map the logical address and the physical address to each other, the memory controller 130 may include a meta data management circuit 20 and a trim command processing circuit 30.

The meta data management circuit 20 may generate meta data including mapping information between logical addresses and physical addresses, and journal data for the meta data. The journal data is history information on the update of the meta data and may be configured as a part of the meta data. The memory controller 130 may derive the meta data before or after the update through the journal data.

That is, when the data storage device 120 is powered off before change details of host data are reflected in the storage 140, the host data may be lost. However, the host data may be updated with the latest data by tracking the journal data which is a record of a process in which the host data is changed.

When a certain file is deleted by the host device 110, the file system of the host device 110 may treat the file as deleted and transmit a trim command including a logical address corresponding to the deleted data to the data storage device 120.

The trim command processing circuit 30 may add, to the meta data, invalidation information indicating that mapping information on a logical address included in the trim command among the mapping information has been invalidated. The fact that the logic level of the invalidation information is set to a first logic level may mean that the corresponding file has been deleted by the host device 110 but has not been internally deleted in the data storage device 120. The data storage device 120 may change the logic level of the invalidation information to a second logic level after erasing data in a data storage area, where the logic level of the invalidation information is set to the first logic level, through a background operation.

After the trim command is received, the trim command processing circuit 30 may generate a trim journal, which is history information until the corresponding file is actually erased, and reflect the trim journal in the journal data. That is, the trim journal may be history information on whether the mapping information has been invalidated.

The meta data generated by the meta data management circuit 20 and the journal data comprising the trim journal generated by the trim command processing circuit 30 may be temporarily stored in the buffer memory device 150.

The memory controller 130 may flush the meta data comprising the journal data, which are stored in the buffer memory device 150, to the storage 140 according to a set period. The meta data comprising the journal data flushed to the storage 140 may be loaded onto the buffer memory device 150 and rebuilt during the power-on process of the data storage device 120.

When a sudden power off (SPO) occurs in a state in which updated meta data is not flushed and the data storage device 120 is powered on again, the meta data loaded onto the buffer memory device 150 from the storage 140 may include information before the update instead of the latest information. The memory controller 130 may rebuild the meta data with the latest information by deriving a process of changing the meta data before or after the update through the journal data.

Particularly, in the present technology, mapping information and invalidation information corresponding to the mapping information may be generated as one set, for example, one meta slice, may be simultaneously stored in the storage 140, and may be simultaneously read from the storage 140. The size of the meta slice may be a flushing unit for the storage 140 or a program unit from another point of view. In an embodiment, the size of the meta slice may correspond to the size of a page or super page. Accordingly, the mapping information and the invalidation information corresponding to the mapping information may be stored in substantially the same page or substantially the same super page of the storage 140.

The data storage device 120 performs a rebuild operation of loading the meta data comprising journal data stored in the storage 140 onto the buffer memory device 150 when the data storage device 120 is powered on and rebuilding the meta data with the latest information, and the time required for the rebuild operation is called open time.

In the present disclosure, mapping information necessary for the rebuild operation and invalidation information corresponding to the mapping information are simultaneously loaded onto the buffer memory device 150 from the storage 140. Accordingly, a rebuild operation on mapping information set to be invalid may be omitted, so that the open time may be reduced.

FIG. 2 is a configuration diagram of the memory controller 130 in accordance with an embodiment of the present disclosure.

Referring to FIG. 2, the memory controller 130 may include a processor 131, a host interface circuit 133, a ROM 1351, a RAM 1353, a memory interface circuit 137, a buffer memory management circuit 139, the meta data management circuit 20, and the trim command processing circuit 30.

The processor 131 may be configured to transmit various control information necessary for a data read or write operation on the storage 140 to the host interface circuit 133, the RAM 1353, the memory interface circuit 137, the buffer memory management circuit 139, the meta data management circuit 20, and the trim command processing circuit 30. In an embodiment, the processor 131 may operate according to firmware provided for various operations of the data storage device 120. In an embodiment, the processor 131 may perform functions of a flash translation layer (FTL) for managing the storage 140, for example, garbage collection, address mapping, wear leveling, and the like. The processor 131 may be a combination of hardware and software operating on the hardware.

The host interface circuit 133 may be an external device interface circuit. The host interface circuit 133 may provide a communication channel for receiving commands and dock signals from an external device, for example, the host device 110, and controlling data input/output under the control of the processor 131. Particularly, the host interface circuit 133 may provide a physical connection between the external device and the data storage device 120. The host interface circuit 133 may also provide interfacing with the data storage device 120 corresponding to a bus format of the external device. The bus format of the external device may include at least one of communication standards or interfaces such as a secure digital, a universal serial bus (USB), a multi-media card (MMC), an embedded MMC (eMMC), a personal computer memory card international association (PCMCIA), a parallel advanced technology attachment (PATA), a serial advanced technology attachment (SATA), a small computer system interface (SCSI), a serial attached SCSI (SAS), a peripheral component interconnection (PCI), a PCI express (PCI-E), and a universal flash storage (UFS).

The ROM 1351 may store program codes necessary for the operation of the memory controller 130, for example, firmware or software, and store code data and the like used by the program codes.

The RAM 1353 may store data necessary for the operation of the memory controller 130 or data generated by the memory controller 130. The RAM 1353 may include, for example, an SRAM, and may be used as a buffer memory, an operation memory, or a cache memory of the memory controller 130.

The memory interface circuit 137 may provide a communication channel for signal transmission/reception between the memory controller 130 and the storage 140. The memory interface circuit 137 may write data temporarily stored in the buffer memory device 150 into the storage 140 under the control of the processor 131. The memory interface circuit 137 may also transmit data read from the storage 140 to the buffer memory device 150 to be temporarily stored,

The buffer memory management circuit 139 may allocate or release an area constituting the buffer memory device 150 in order to temporarily store data in the buffer memory device 150.

The meta data management circuit 20 may generate meta data including mapping information between logical addresses and physical addresses on the basis of an address mapping operation of the processor 131 and journal data for the meta data, and temporarily store the generated data in the buffer memory device 150.

The trim command processing circuit 30 may add invalidation information, which indicates that mapping information to be trimmed among the mapping information generated by the meta data management circuit 20 has been invalidated, to the meta data in response to a trim command from the external device. The trim command processing circuit 30 may reflect trim history information e.i., the trim journal to journal data. In an embodiment, the invalidation information generated according to the trim command may be bitmap data, and may be referred to as a trim bitmap TBM. Accordingly, the meta data may include at least mapping information including the trim bitmap TBM and journal data corresponding to the mapping information.

The trim command processing circuit 30 may set the logic level of the trim bitmap TBM of corresponding mapping information to a first logic level in response to the trim command of the external device. The processor 131 may erase, through a background trim operation, data in a storage area where the logic level of the trim bitmap TBM is the first logic level and may recover an available storage capacity of the storage area through a wear leveling or garbage collection operation. As the data in a storage area where the trim bitmap TBM has the first level is erased, the trim command processing circuit 30 may change the logic level of the trim bitmap TBM to a second logic level, generate a trim journal indicating such history, and reflect the generated trim journal to the journal data.

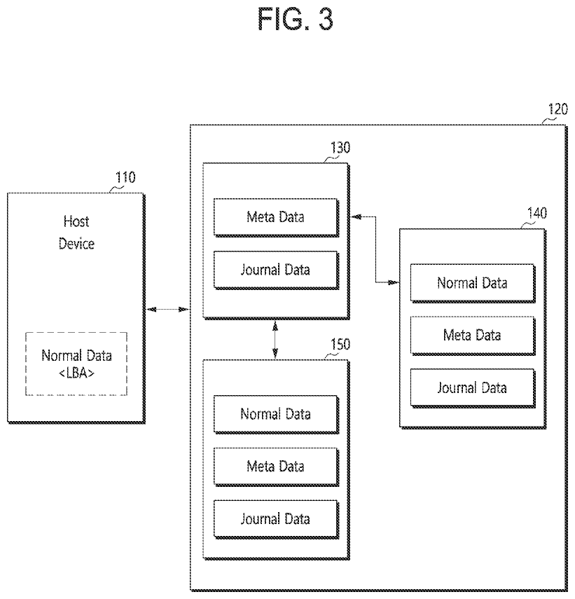

FIG. 3 is a diagram for describing a meta data management concept in accordance with an embodiment of the present disclosure.

In order to store data requested by an external device, for example, the host device 110 in a storage space including a nonvolatile memory cell, the data storage device 120 may perform mapping of connecting the file system used by the host device 110 and the storage space provided in the storage 140. When the host device 110 transmits a logical address LBA to the data storage device 120 together with a write command and data, the data storage device 120 may search for a storage space for storing data in the storage 140, map a physical address of the searched storage space to the logical address LBA provided by the host device 110, and then program data to the searched storage space. When the host device 110 transmits the logical address LBA to the data storage device 120 together with a read command, the data storage device 120 may search for a physical address mapped to the logical address LBA and then output data stored in the searched physical address to the host device 110.

That is, the host device 110 may manage normal data Normal Data, for example, user data, by using the logical address LBA. The memory controller 130 of the data storage device 120 may map the logical address LBA from the host device 110 to a physical address indicating a physical space inside the storage 140 in which the Normal Data is stored, and store the Normal Data in the mapped physical space.

Logical-physical address mapping information may be generated as meta data Meta Data.

The mapping information included in the Meta Data may also be updated in response to a value of the Normal Data being updated by the host device 110 according to the operation of the data processing system 100. The memory controller 130 may store internally generated or updated Meta Data in the buffer memory device 150. The memory controller 130 may generate journal data Journal Data that is history information on the update of the Meta Data and store the Journal Data in the buffer memory device 150.

The operation of generating the Meta Data by napping the logical address LBA to the physical address, and the operation of generating the Journal Data by collecting the history information on the update of the Meta Data may be performed by a flash translation layer (FTL) unit (not illustrated) included in the memory controller 130.

The Normal Data inputted/outputted between the host device 110 and the data storage device 120 and the Meta Data comprising Journal Data generated corresponding to the Normal Data may be temporarily stored in the buffer memory device 150 and then flushed to the storage 140.

After the data storage device 120 is powered on, the Meta Data comprising Journal Data stored in the storage 140 may be loaded onto the buffer memory device 150 and rebuilt with the latest information.

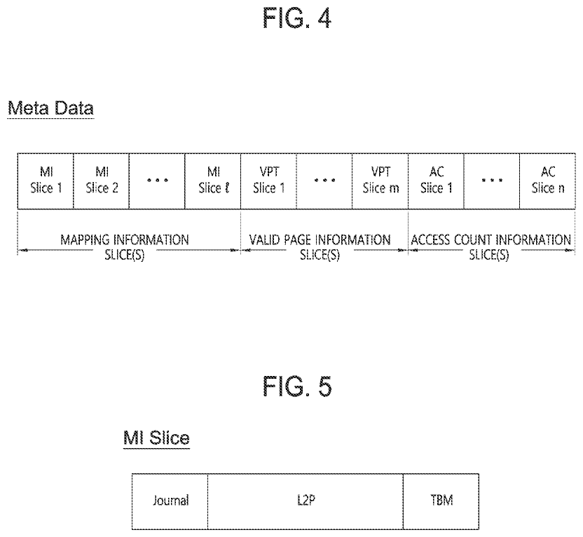

FIG. 4 is a configuration diagram of the Meta Data in accordance with an embodiment of the present disclosure,

Referring to FIG. 4, the Meta Data may include a plurality of logical-physical address mapping information slices MI Slice 1 to MI Slice l. The Meta data may further include at least some of a plurality of valid page information slices VPT slice 1 to VPT slice m and a plurality of access count information slices AC Slice 1 to AC slice n.

The logical-physical address flapping information slices MI Slice 1 to MI Slice l may store mapping information between a logical address received from the host device 110 and a physical address for the memory space of the storage 140.

The valid page information slices VPT slice 1 to VPT slice m may store information on a page or super page storing valid data among pages or super pages included in the storage 140.

The memory controller 130 may secure an available space of the storage 140 and extend the lifespan of the storage 140 by house-keeping operations such as garbage collection and wear leveling operations, and in this case, valid page information may be referenced and updated.

The access count information slices AC Slice 1 to AC Slice n may store the number of erases and the number of reads for memory blocks.

The memory controller 130 may perform a read reclaim operation or a wear leveling operation on the basis of an access count and update access count information.

As illustrated in FIG. 4, the memory controller 130 may divide the Meta Data into a plurality of meta slices MI Slice 1 to MI Slice l, VPT slice 1 to VPT slice m, and AC Slice 1 to AC Slice n, and manage the divided slices. The memory controller 130 may flush the Meta Data in units of meta slices. The flushing time points according to the type of meta slice may be set to be the same as or different from each other.

FIG. 5 is a configuration diagram of the meta slice in accordance with an embodiment of the present disclosure, and is a configuration diagram of the logical-physical address mapping information slices MI Slice 1 to MI Slice l.

Referring to FIG. 5, each logical-physical address mapping information slice MI Slice may include a journal field Journal, mapping data field L2P, and a trim bitmap field TBM.

Mapping information between logical addresses and physical addresses may be stored in the mapping data field L2P.

A bitmap value according to the trim command of the host device 110 and a background trim operation of the data storage device 120 may be stored in the trim bitmap field TBM. That is, it may be checked by the value stored in the trim bitmap field TBM whether corresponding data has been deleted only by the host device 110.

In an embodiment, the fact that the logic level of the trim bitmap TBM has been set to the first logic level may mean that a corresponding file has been deleted by the host device 110 but has not been internally deleted from the data storage device 120. The data storage device 120 may change the logic level of the trim bitmap TBM to the second logic level after erasing data in the data storage area, where the logic level of the trim bitmap TBM has been set to the first logic level, through a background trim operation.

History information on the update of mapping data L2P, that is, history before or after the update of the flapping data L2P may be stored in the journal field Journal. The journal field Journal may also include trim history information until a trim command is received and a corresponding file is actually erased.

As illustrated in FIG. 5, the mapping data L2P and the trim bitmap TBM, which is invalidation information corresponding to the mapping data L2P, may be generated as one meta slice, for example, a mapping information slice MI Slice. The size of the meta slice may correspond to the size of a page or a super page. Accordingly, the mapping data L2P and the trim bitmap TBM corresponding to the mapping data L2P may be simultaneously stored in substantially the same page or substantially the same super page of the storage 140, and may be simultaneously read and used in a rebuild operation when the data storage device 120 is powered on.

During the rebuild operation, a rebuild operation on the mapping data L2P of data already deleted by the host device 110 may be omitted on the basis of the trim bitmap TBM, so that the open time may be reduced.

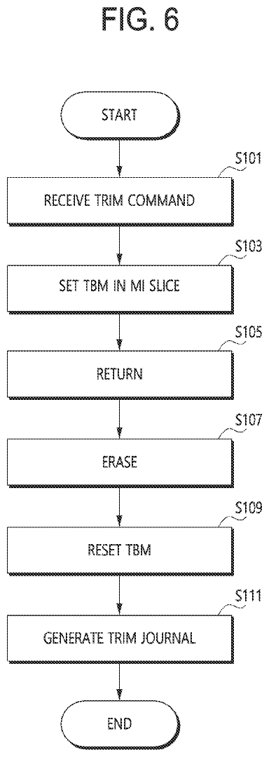

FIG. 6 is a flowchart for describing an operating method of the data storage device 120 in accordance with an embodiment of the present disclosure, and illustrates a trim command processing method.

Referring to FIG. 6, the data storage device 120 may receive the trim command from the host device 110 (S101). The trim command may include a logical address of a file or data deleted by the host device 110.

The memory controller 130 of the data storage device 120 may set the trim bitmap TBM of the mapping information slice MI Slice to indicate that data corresponding to the logical address included in the trim command has been deleted by the host device 110, that is, corresponding mapping information has been invalidated (S103). For example, the memory controller 130 may set the logic level of the trim bitmap field TBM to the first level, and return the result to the host device 110 (S105). When the logic level of the trim bitmap field TBM of the mapping information slice MI Slice is set to the first logic level, the corresponding mapping information slice MI Slice may be marked as dirty.

The fact that the logic level of the trim bitmap TBM has been set to the first logic level may mean that the corresponding file has been deleted by the host device 110 but has not been internally deleted from the data storage device 120.

The fact that the meta slice is in a dirty state may mean that the meta slice updated by the memory controller 130 has not yet been flushed to the storage 140.

The memory controller 130 of the data storage device 120 may control the storage 140 through a background trim operation and erase data in a data storage area where the logic level of the trim bitmap TBM is set to the first logic level (S107). The memory controller 130 may change the logic level of the trim bitmap TBM for the mapping information of the storage area, where the data has been erased by the background trim operation, to the second logic level (S109).

The memory controller 130 may generate a trim journal that is trim history information until the trim command is received and the corresponding data is actually erased, and reflect the trim journal to the journal field in the mapping information slice MI Slice (S111).

In this way, logical-physical address mapping information and a trim bitmap TBM therefor may be generated as one set, that is, one meta slice.

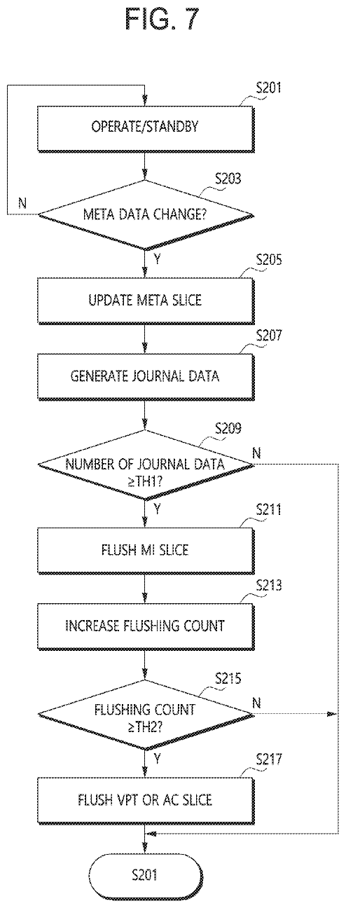

FIG. 7 is a flowchart for describing an operating method of the data storage device 120 in accordance with an embodiment of the present disclosure, and illustrates a meta data flushing method.

The data storage device 120 may monitor whether the Meta Data has been changed, during operation or standby (S201) under the control of the host device 110 (S203).

When the Meta Data has not been changed (S203: N), the data storage device 120 may operate or stand by under the control of the host device 110 (5201).

When the Meta Data has been changed (5203: Y), the memory controller 130 of the data storage device 120 may update a meta slice according to the changed Meta Data (S205). The updated mapping information slice MI Slice may be marked as dirty.

In addition, the memory controller 130 may generate the change process before and after the update of the changed Meta Data as Journal Data and store the Journal Data in the meta slice (S207).

For example, the mapping data L2P may be changed according to an overwrite request from the host device 110. Accordingly, the mapping data L2P in the mapping information slice MI Slice of the meta slice may be updated, and Journal Data may be generated accordingly. The Journal Data may be generated each time the mapping data L2P is changed. Accordingly, at least one Journal Data may be stored in one mapping information slice MI Slice with respect to the mapping data L2P.

The memory controller 130 may check whether the number of Journal Data included in the mapping information slice MI Slice is equal to or greater than a preset first threshold number TH1 (S209).

When the number of Journal Data is equal to or greater than the first threshold number TH1 (S209: Y), the memory controller 130 may flush the mapping information slice MI Slice to the storage 140 (S211) and increase the flushing count (S213). In such a case, the memory controller 130 may flush, to the storage 140, the mapping information slice MI Slice marked as dirty and having the number of journal data equal to or greater than the first threshold number TH1. The mapping information slice MI Slice flushed to the storage 140 may be marked as a clean state.

The memory controller 130 may check whether the number of flushing of the mapping information slice MI Slice is equal to or greater than a preset first threshold value TH2 (S215).

When the number of flushing is greater than or equal to the preset first threshold value TH2 (S215: Y), the memory controller 130 may flush other meta slices other than the mapping information slice MI Slice, for example, the valid page information slices VPT slice 1 to VPT slice m or the plurality of access count information slices AC Slice 1 to AC slice n, to the storage 140 by a designated number (S217), and operate or stand by under the control of the host device 110 (S201).

Since the trim bitmap TBM for the mapping information L2P is included in the mapping information slice MI Slice, the mapping information L2P and the trim bitmap TBM may be flushed together in operation S211. When the trim bitmap TBM is flushed at a time point different from the mapping information slice MI Slice, for example, in operation S217, the mapping data L2P and the trim bitmap TBM may not be flushed into the same page, which causes an increase in a number of times that a read operation is performed to read the mapping data L2P and the trim bitmap TBM. For example, a SPO may occur after flushing a mapping information slice MI Slice including no trim bitmap TBM. Then, when the data storage device 120 is powered on, the memory controller 130 needs to rebuild the mapping data L2P by using the trim bitmap TBM stored at the previous time point and the mapping information slice MI Slice flushed just before the SPO, resulting in an increase in the open time.

However, according to the present technology, since the mapping information L2P and the trim bitmap TBM therefor are simultaneously flushed and read, the Meta Data may be rebuilt in a short time by using the trim bitmap TBM in which the validity of the mapping information L2P is reflected in real time.

When the number of Journal Data is less than the first threshold number TH1 (S209: N) and the number of flushing is less than the preset first threshold value TH2 (S215: N), the memory controller 130 may operate or stand by under the control of the host device 110 (S201).

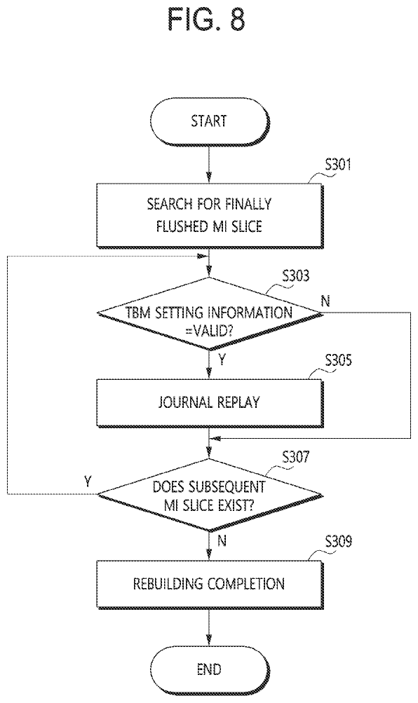

FIG. 8 is a flowchart for describing an operating method of the data storage device 120 in accordance with an embodiment of the present disclosure, and illustrates a mapping information rebuilding method.

Referring to FIG. 8, as the data storage device 120 is powered on, the memory controller 130 may search for a mapping information slice MI Slice finally flushed to the storage 140 and load the searched mapping information slice MI Slice onto the buffer memory device 150 (S301).

The memory controller 130 may determine whether corresponding mapping data L2P is valid, according to the trim bitmap TBM included in the mapping information slice MI Slice loaded onto the buffer memory device 150 (S303). For example, when the logic level of the trim bitmap TBM is set to the second logic level, it may be determined that the corresponding mapping data L2P is valid.

When the mapping data is valid (S303: Y), the memory controller 130 may replay Journal Data in the loaded mapping information slice MI Slice to rebuild the mapping data L2P (S305).

After the rebuilding of the loaded mapping data L2P is completed or when it is determined that the mapping data is invalid because the logic level of the trim bitmap TBM is set to the first logic level (S303: N), the memory controller 130 may determine whether a subsequent mapping information slice MI Slice exists (S307).

When the subsequent mapping information slice MI Slice exists (S307: Y), the memory controller 130 may perform operation S303 of loading the subsequent mapping information slice MI Slice onto the buffer memory device 150 and checking whether the mapping data L2P is valid according to the trim bitmap TBM.

When the subsequent mapping information slice MI Slice does not exist (S307: N), the memory controller 130 may complete the rebuilding process by storing the rebuilt mapping information in the storage 140 (S309).

According to the present technology, mapping information and its validity information may be treated as one set, stored in a storage medium at substantially the same time point, and read from the storage medium at substantially the same time point. Accordingly, overhead for synchronizing the mapping information and the validity information may be reduced.

A person skilled in the art to which the present disclosure pertains can understand that the present disclosure may be carried out in other specific forms without changing its technical spirit or essential features. Therefore, it should be understood that the embodiments described above are illustrative in all respects, not limitative. The scope of the present disclosure is defined by the claims to be described below rather than the detailed description, and it should be construed that the meaning and scope of the claims and all changes or modified forms derived from the equivalent concept thereof are included in the scope of the present disclosure. Furthermore, the embodiments may be combined to form additional embodiments.

What is claimed is:

1. A data storage device comprising:
a storage configured to receive and program data in units of first sizes or read and output data in the units of first sizes; and
a memory controller configured to
control data input/output to/from the storage according to mapping data between a logical address used by an external device and a physical address used by the storage,
generate a mapping information slice having the first size as a trim command including a first logical address which is transmitted thereto from the external device, the mapping information slice including trim bitmap data and first mapping data for the first logical address, and
store the mapping information slice in the storage.

2. The data storage device according to claim 1, wherein the memory controller is further configured to generate the trim bitmap data to indicate that the first mapping data has been invalidated.

3. The data storage device according to claim 1, wherein the memory controller is configured to simultaneously store the trim bitmap data and the first mapping data, which are included in the mapping information slice, in the storage.

4. The data storage device according to claim 3, wherein the memory controller is further configured to simultaneously read the trim bitmap data and the first mapping data, which are included in the mapping information slice, from the storage.

5. The data storage device according to claim 1, wherein the memory controller is further configured to read the mapping information slice from the storage during power-on, and determine whether to rebuild the first mapping data on the basis of the trim bitmap data included in the read mapping information slice.

6. A memory controller comprising:
a meta data management circuit configured to generate a mapping information slice including mapping data between a logical address of an external device and a physical address of a storage;
a trim command processing circuit configured to generate trim bitmap data as a trim command including a first logical address which is transmitted from the external device, and configure a mapping information slice having a first size by putting the trim bitmap data into the mapping information slice including first mapping data for the first logical address; and
a processor configured to control data input/output to/from the storage in units of the first sizes and store the mapping information slice in the storage.

7. The memory controller according to claim 6, wherein the trim command processing circuit is configured to generate the trim bitmap data to indicate that the first mapping data has been invalidated.

8. The memory controller according to claim 6, wherein the processor is configured to simultaneously store the trim bitmap data and the first mapping data, which are included in the mapping information slice, in the storage.

9. The memory controller according to claim 8, wherein the processor is further configured to simultaneously read the trim bitmap data and the first mapping data, which are included in the mapping information slice, from the storage.

10. The memory controller according to claim 6, wherein the processor is further configured to read the mapping information slice from the storage during power-on, and determine whether to rebuild the first mapping data on the basis of the trim bitmap data included in the read mapping information slice.

11. An operating method of a data storage device, the operating method comprising:
preparing a storage that receives and programs data in units of first sizes, or reads and outputs data in the units of first sizes;
generating, by a memory controller that controls the storage, a mapping information slice including mapping data between a logical address used by an external device and a physical address used by the storage;
generating, by the memory controller, trim bitmap data for a first logical address as a trim command including the first logical address which is received from the external device;
configuring, by the memory controller, a mapping information slice having the first size by putting the trim bitmap data into the mapping information slice including first mapping data for the first logical address; and
storing, by the memory controller, the mapping information slice in the storage.

12. The operating method according to claim 11, wherein the trim bitmap data is generated to indicate that first mapping data has been invalidated.

13. The operating method according to claim 11, wherein the storing includes simultaneously storing, by the memory controller, the trim bitmap data and the first mapping data, which are included in the mapping information slice, in the storage.

14. The operating method according to claim 13, further comprising simultaneously reading, by the memory controller, the trim bitmap data and the first mapping data, which are included in the mapping information slice, from the storage.

15. The operating method according to claim 11, further comprising:
reading, by the memory controller, the mapping information slice from the storage during power-on; and
determining whether to rebuild the first mapping data on the basis of the trim bitmap data included in the read mapping information slice.

16. An operating method of a controller, the operating method comprising:
flushing, in units of pages, one or more map slices from a buffer into a memory device; and
rebuilding a mapping relationship between logical and physical addresses indicating a storage unit by loading, in the units of pages, one or more of the flushed map slices from the memory device onto the buffer,
wherein each of the map slices includes:
first information representing the mapping relationship, and
second information indicating whether the mapping relationship is invalid, and
wherein the rebuilding includes referring to the second information within the loaded map slices.
